(19) United States
(12) Patent Application Publication
(10) Pub. No.: US 2011/0012555 A1
(43) Pub. Date: Jan. 20, 2011

(54) CHARGING DEVICE AND CONNECTION ELEMENT

(75) Inventor: Michael Schjerbeck Jensen, Guangzhou City (CN)

Correspondence Address: VIERING, JENTSCHURA & PARTNER, 3770 HIGHLAND AVE., SUITE 203, MANHATTAN BEACH, CA, 90266, US

(73) Assignee: Nomenta Industries (HK) Ltd., Guangzhou City (CN)

(21) Appl. No.: 12/838,539

(22) Filed: Jul. 19, 2010

(30) Foreign Application Priority Data
Jul. 20, 2009 (HK) 09106608.2

(51) Int. Cl. H02J 7/00

(52) U.S. Cl. 320/107

(57) ABSTRACT

A charging device is described that includes a charging device base having a plurality of first connection element interfaces and a plurality of connection elements, each connection element a second connection element interface and being removably coupled with the charging device base by a coupling of its second connection element interface with a first connection element interface. At least one connection element of the plurality of connection elements includes a speaker for outputting an audio signal supplied to the connection element or includes a battery compartment for charging a battery.

### CROSS-REFERENCE TO RELATED APPLICATION

This application claims priority to Hong Kong Patent Application Serial No. 09106608.2, which was filed Jul. 20, 2009, and is incorporated herein by reference in its entirety.

### TECHNICAL FIELD

Embodiments relate to a charging device and a connection element for a charging device.

### BACKGROUND

Portable electronic devices, such as mobile phones, PDAs (Personal Digital Assistants) and MP3 players are widely used today.

Such a portable electronic device typically includes a chargeable battery for energy storage which provides it with power when the electronic device is in active mode or standby mode.

For charging the battery of an electronic device, charging devices are known which include a connection interface, e.g. a plug, suitable for connecting the electronic device and charging the electronic device, i.e. its battery, such that the battery does not have to be removed from the electronic device for charging.

### SUMMARY

A charging device is described that includes a charging device base having a plurality of first connection element interfaces and a plurality of connection elements, each connection element a second connection element interface and being removably coupled with the charging device base by a coupling of its second connection element interface with a first connection element interface. At least one connection element of the plurality of connection elements comprises a speaker for outputting an audio signal supplied to the connection element or comprises a battery compartment for charging a battery.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a charging device according to an embodiment.

FIG. 2 shows a functional view of a charging device according to an embodiment.

FIG. 3 shows a charging device according to an embodiment.

FIG. 4 shows a charging device according to an embodiment.

FIG. 5 shows a connection element according to an embodiment.

FIG. 6 shows a functional view of a charging device according to an embodiment.

FIG. 7 shows a functional view of a charging device according to an embodiment.

FIG. 8 shows a charging device according to an embodiment.

FIG. 9 shows a charging device according to an embodiment.

FIG. 10 shows a connection element according to an embodiment.

FIG. 11 shows a functional view of a charging device according to an embodiment.

FIG. 12 shows a functional view of a charging device according to an embodiment.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Embodiments may be seen to be based on the problem to provide a charging device which is more versatile than known charging devices.

According to one embodiment, a charging device is provided that includes a charging device base including a plurality of first connection element interfaces and a plurality of connection elements, each connection element including a second connection element interface and being removably coupled with the charging device base by a coupling of its second connection element interface with a first connection element interface. At least one connection element of the plurality of connection elements includes a speaker, the second connection element interface of the at least one connection element is configured such that the connection element, if the second connection element interface is coupled with a first connection element interface, receives power from the charging device base for operating the speaker, and the at least one connection element includes an audio interface for receiving an audio signal and is configured to output sounds corresponding to the audio signal using the speaker.

According to another embodiment, a charging device is provided including a charging device base including a plurality of first connection element interfaces and a plurality of connection elements, each connection element including a second connection element interface and being removably coupled with the charging device base by a coupling of its second connection element interface with a first connection element interface. At least one connection element of the plurality of connection elements includes a battery compartment, a battery charging circuit configured to, if a battery is inserted into the battery compartment, receive power and generate, depending on a charging characteristic of the battery, charging power for charging the battery from the received power, wherein the second connection element interface of the at least one connection element is configured such that the battery charging circuit, if the second connection element interface is coupled with a first connection element interface, receives the power from the charging device base via the second connection element interface.

Furthermore, connection elements according to the charging devices described above may be provided according to further embodiments.

Embodiments which are described in the context of a charging device are analogously valid for the corresponding connection element.

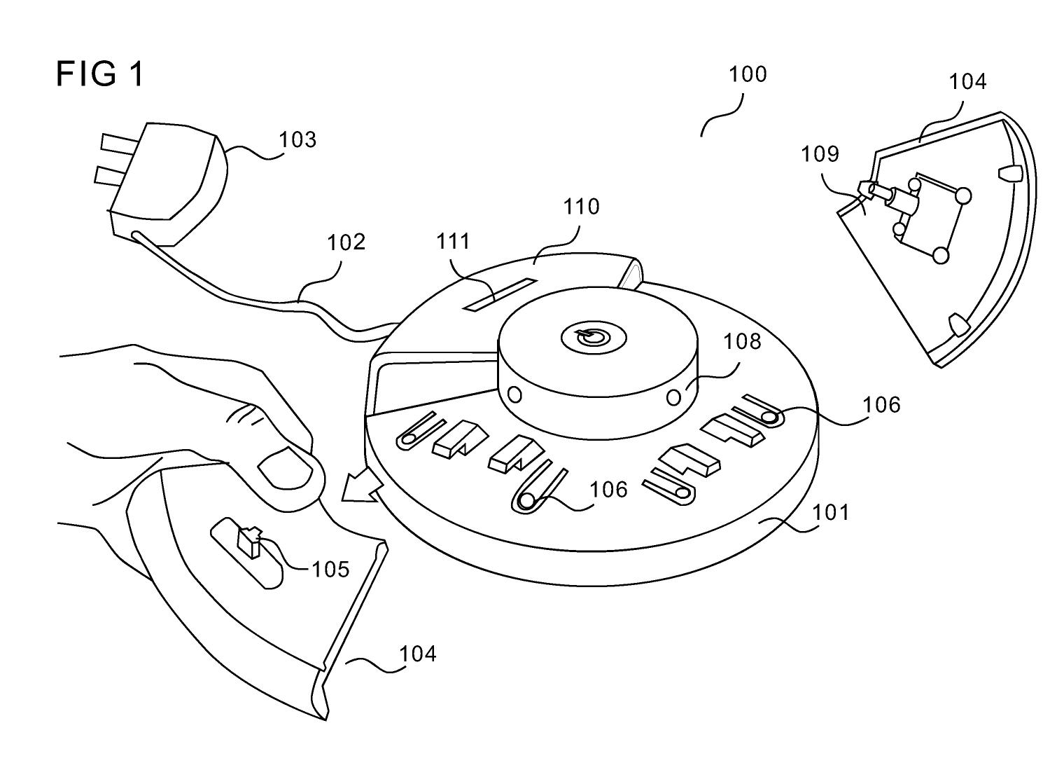

FIG. 1 shows a charging device 100 according to an embodiment.

The charging device 100 includes a charging device base 101, which may also be referred to as base unit. In the embodiment shown in FIG. 1, the charging device base 101 is substantially circular but it may have other shapes according to other embodiments.

The charging device 100 further includes a power cord 102 coupled with the charging device base 101 and a power plug 103 coupled with the power cord 102. The power plug 103 may be coupled with a power socket such that electric power may be supplied via the power plug 103 and the power cord 102 to the charging device base 101.

The power plug 103 may include an adaptor circuit which converts AC power supplied to the power plug 103, e.g. from a power socket, to DC power for supplying it to the charging device base 101. In one embodiment, the adaptor circuit is included in the charging device base 101 and AC power is supplied by the power cord 102 to the charging device base 101 and converted to DC power in the charging device base 101.

The charging device 100 includes a plurality of removable connection elements 104, which may have, e.g. in this embodiment, the shape of a slice and may therefore also be referred to as removable connector slices 104. Each connection element 104 includes a charging interface 105, e.g. in the form of a connection plug, for coupling an electronic device to the connection element 104.

The connection elements 104 may be removably attached to the charging device base 101 by respective first fixing elements 106 of the charging device base 101 and, for example, respective second fixing elements (not shown) of the connection elements 104. The charging device base 101 includes a plurality of first (base side) connection interfaces 108 and each connection element 104 includes a second (element side) connection interface 109. When a connection element 104 is attached to the charging device base 101 using the first fixing elements 106 and the second fixing elements of the connection element 104 the respective first connection interface 108 is coupled with the second connection interface 109 of the connection element 104.

In one embodiment, the connection elements 104 may be attached to the charging device such that they are arranged around a center portion of the charging device base 101 having a circular profile (i.e. a circular cross section). The connection elements 104 have, in this embodiment, a cross section of the form of a circular ring sector, such that, if the maximum number of connection elements 104 is attached to the charging device base 101, the connection elements 104 form with the center portion of the charging device base 101 a circular cross section. As illustrated in FIG. 1, the second (element side) connection interface 109 of a connection element 104 may be directed to the center portion of the charging device base 101 when the connection element 104 is attached to the charging device base 101. The charging device base 101 may also have a circular form in accordance with the form of the connection elements 104, such that, when the maximum number of connection elements 104 (e.g. four) is attached to the charging device base 101, the charging device 100 has substantially the form of a (flat) cylinder, for example with a domed top surface and a planar undersurface. In the center of the top surface, as shown in FIG. 1, the charging device 100 may for example include a power switch, e.g. in the form of a button.

Power supplied to the charging device base 101 by the power cord 102 may be supplied to a connection element 104 attached to the charging device base 101 via the respective first connection interface 108 and the second connection interface of the connection element 104. By connecting an electronic device to the connection element 104 using the charging interface 105, the electronic device may be charged using the power supplied to the connection element 104.

The charging interfaces 105 of different connection elements 104 may differ such that different electronic devices having different requirements with regard to the charging interface 105 (e.g. require different types of plugs) may be charged using different charging interfaces 105.

Since the charging interfaces 105 may be removably attached to the charging device base 101, the charging device 100 may thus be adapted to the charging of various electronic devices having different requirements with regard to the charging interface via which they are charged.

If a first connection interface 108 is suitable for charging an electronic device, the electronic device may also be connected to the charging device base 101 directly via the first connection interface 108, i.e., without an intermediate connection element 104.

In the embodiment shown in FIG. 1, three removable connection elements 104 may be connected at the same time to the charging device base 101. The charging device 100 further includes a fixed connection element 110 which is fixedly attached (i.e. not easily removable) to the charging device base 101. The fixed connection element 110 for example includes a USB output port 111 which may also be used for charging an electronic device and which is supplied by the charging device base 101 such that the number of power output ports of the charging device base 101 for charging electronic devices is four in this embodiment. Other numbers of power output ports may present in other embodiments.

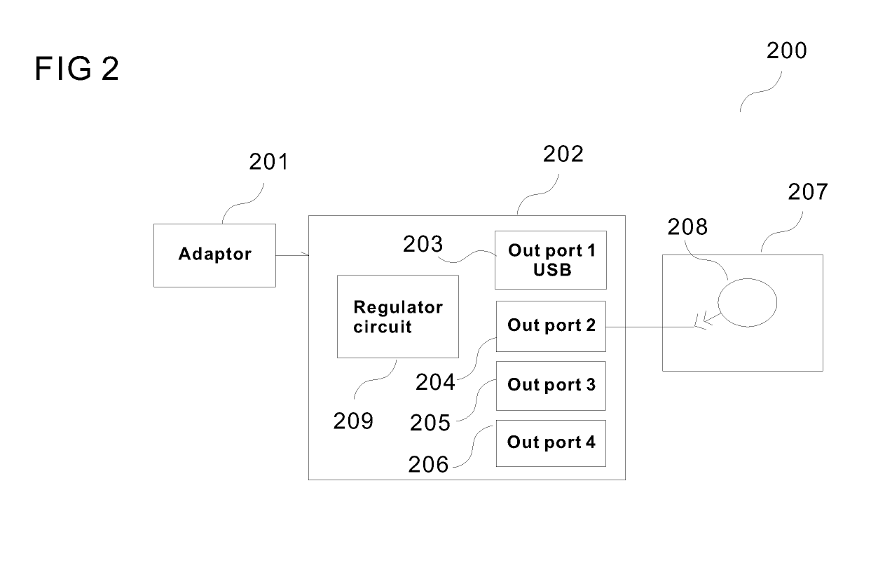

FIG. 2 shows a functional view of a charging device 200 according to an embodiment.

The charging device 200 for example corresponds to the charging device 100.

The charging device 200 includes an adaptor element 201, for example an adaptor circuit 201 for AC/DC power conversion as explained with reference to FIG. 1. The adaptor element 201 supplies electric power to a charging device base 202 of the charging device 200, which, in this example, includes a first power output port 203, a second power output port 204, a third power output port 205 and a fourth power output port 206. For example, the first power output port 203 supplies power to a fixed connection element, e.g. having a USB interface, attached to the charging device base 202 and the second power output port 204, the third power output port 205, and the fourth power output port 206 are (base side) connection interfaces for connecting removable connection elements to the charging device base 202.

The adaptor element 201 may, in one embodiment, also be arranged in the charging device base 202.

If a user of the charging device 200 wants to charge an electronic device using the charging device 200 which may not be charged using the interface of the fixed connection element (e.g. a USB interface) or if the user does not want to use this interface, the user may select a removable connection element 207 based on the charging interface requirements of the electronic device to be charge and connect it to the charging device base 202, for example using the second power output port 204.

The user may select the removable connection element 207 from a plurality of removable connection elements 207 such that the charging interface 208 of the selected removable connection element 207 fits the requirements of the electronic device, e.g. has a plug shape that fits with a socket of the electronic device.

The charging device 200 may further include a regulating circuit 209 controlling the power output via the second power output port 204 to the connection element 207. For example, the regulating circuit 209 may control the voltage or the current supplied to the connection element 207 according to the characteristics (e.g. the type) of the charging interface the connection element 207 provides.

In one embodiment, instead of connecting a connection element 104 to the charging device base 101 which serves for charging an electronic device, i.e. provides a charging interface 105 for connecting an electronic device for charging the electronic device, a connection element may be attached to and coupled with the charging device base 101 that provides a different functionality than charging.

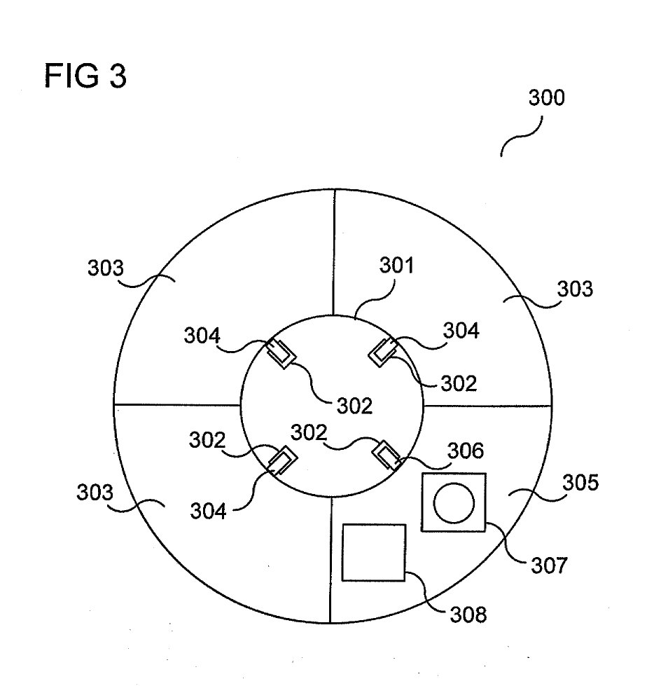

In one embodiment, such a connection element may provide a speaker for outputting audio signals. This is explained in the following with reference to FIG. 3.

FIG. 3 shows a charging device 300 according to an embodiment.

The charging device 300 includes a charging device base 301 including a plurality of first connection element interfaces 302 (e.g. sockets or jacks) and a plurality of connection elements 303, 305. Each connection element 303, 305 includes a second connection element interface 304, 306 (e.g. a plug) and is removably coupled to the charging device base 301 by a coupling of its second connection element interface 304, 306 with a respective first connection element interface 302.

At least one connection element 305 of the plurality of connection elements 303, 305 includes a speaker 307 and the second connection element interface 306 of the connection element 305 is configured such that the connection element 305, if the second connection element interface 306 is coupled with a first connection element interface 302, receives power from the charging device base 301 for operating the speaker 307. Further, the connection element 305 includes an audio interface 308 for receiving an audio signal and is configured to output sounds corresponding to the audio signal using the speaker 307.

In other words, a portion (e.g. a slot) of the charging device for connecting a connection element is used for connecting a connection element including a speaker that may be used, instead of charging an electronic device, for outputting audio signals. For example, the charging device may thus be used as an audio output system (e.g., in one embodiment, including an amplifier) for an electronic device which may, at the same time, be charged using the charging device. Thus, the functionality of the charging device may be seen to be extendable (by connecting a corresponding connection element) by an audio output capability.

In one embodiment, at least one other connection element of the plurality of connection elements includes a charging interface for connecting an electronic device to the connection element such that the electronic device may be charged by the charging device via the charging connection element.

In one embodiment, the charging device base includes a base output audio interface configured to output the audio signal to the audio interface of the connection element.

The first connection interfaces may be sockets and the second connection interface may be a corresponding plug. Alternatively, the first connection interfaces may be plugs and the second connection interface may be a corresponding socket.

The charging device base may include a center portion and the plurality of first connection element interfaces may be arranged such that the plurality of connection elements are arranged around the center portion.

In one embodiment, the audio interface is a wireless audio interface configured to receive the audio signal wirelessly. For example, the audio interface is a radio interface configured to receive the audio signal via a radio signal.

In one embodiment, the at least one connection element includes an audio amplifier for amplifying the audio signal.

In one embodiment, the audio interface is configured to receive a stereo audio signal including a first channel audio signal and a second channel audio signal, the connection element includes an output audio interface and the audio interface of the connection element is configured to output the first channel audio signal to the output audio interface and the connection element is configured to output sounds corresponding to the second channel audio signal using the speaker.

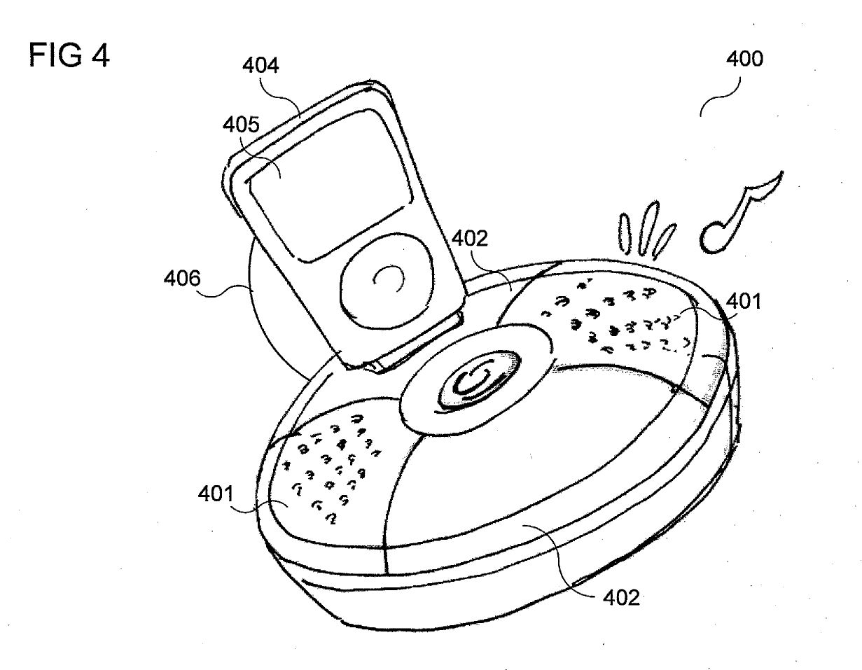

An example for a charging device including connection elements with speakers is shown in FIG. 4.

FIG. 4 shows a charging device 400 according to an embodiment.

The charging device 400 includes a plurality of connection elements 401, 402, some of which or all may be removable, wherein two first connection elements 401 of the plurality of connection elements 401, 402 include speakers.

Two second connection elements 402 of the plurality of connection elements 401, 402 may be connection elements including charging interfaces as explained above with reference to FIG. 1.

An electronic device 404 is coupled with one of the second connection elements 402 and may, for example, be charged via the second connection element 402. It may also be the case that the electronic device 404 is not charged but is just attached (e.g. using a plug or fixing elements) to have it in an upright position such that it can be easily accessed or such that a display 405 of the electronic device 404 may be easily viewed by the user.

The electronic device 404 is, in this example, an electronic device providing an audio signal, e.g. a mobile phone or an MP3 player.

The electronic device 404 may be coupled to the charging device 400 such that the audio signal may be supplied to the charging device 400. For example, the electronic device 404 is connected using an audio cable 406 to the base of the charging device 400 or to one of the connection elements 401, 402. For example, the first connection elements 401 including speakers also include an audio interface for connecting an audio cable and supplying an audio signal to the first connection element 401 which may be output using the speaker.

In one embodiment, an audio cable is not necessary but an audio interface of the electronic device may be directly plugged into an audio interface of a connection element 401, 402 (which may be a special connection element 401, 402 for this purpose). In this case, an audio signal may for example be supplied via one connection element 401, 402 to the base of the charging device 400 and the audio signal may be supplied to a first connection element 401 including a speaker by the base of the charging device 400. For this, the base of the charging device 400 and the first connection element 401 may include corresponding audio interfaces. For example, a first connection elements 401 includes an audio plug and the base of the charging device 400 includes an audio socket (or vice versa) which are connected with each other when the first connection element 401 is attached to the base of the charging device 400.

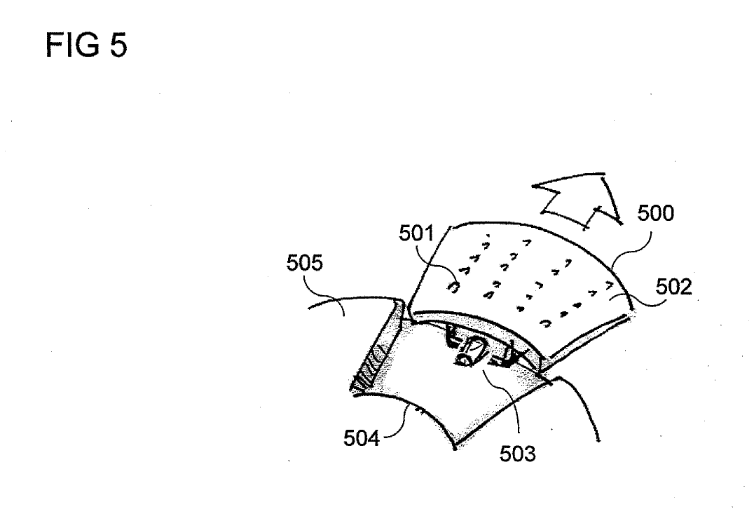

The first connection elements 401 are, in one embodiment, removable from the base of the charging device 400. This is illustrated in FIG. 5.

FIG. 5 shows a connection element 500 according to an embodiment.

The connection element 500 for example corresponds to one of the first connection elements 401 shown in FIG. 4.

The connection element 500 includes a speaker, for which a plurality of holes 501 may be provided in a top 502 of the connection element 500.

Power for operating the speaker may be supplied to the connection element 500 via a (connection element side) second connection element interface 503 which may be coupled to a (base side) first connection element interface 504 of the charging device base 505.

The connection element 500 may be removably attached to the charging device base 505 similarly to the connection elements 104 of the charging device 100 shown in FIG. 1, for example by a sliding movement in the direction of the center of the charging device base 505.

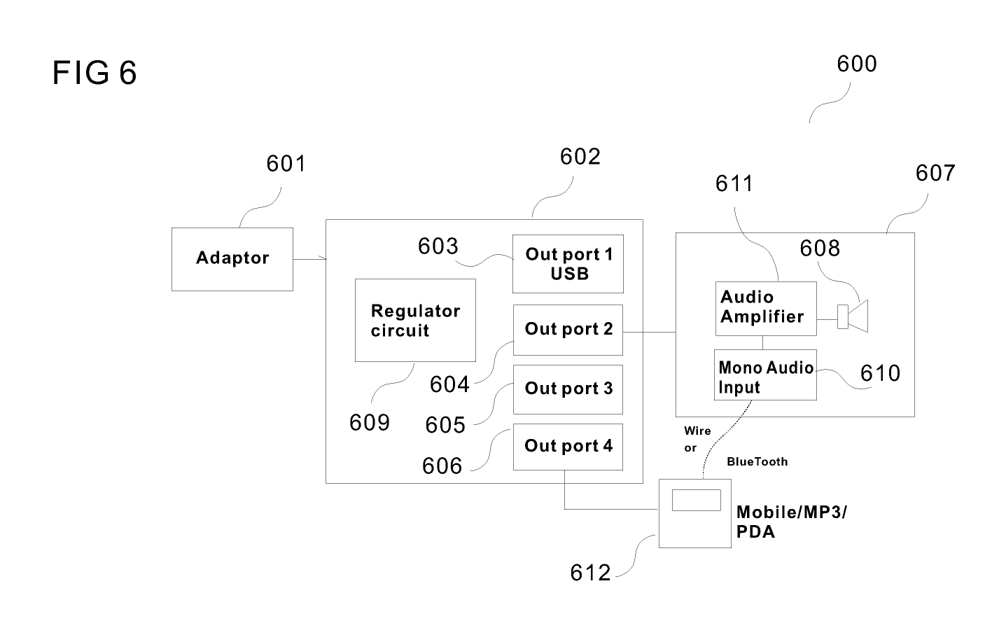

The functionality of the speaker connection elements, i.e. the first connection elements 401 including speakers, which may also be referred to as speaker slices, according to one embodiment is further described in the following with reference to FIG. 6.

FIG. 6 shows a functional view of a charging device 600 according to an embodiment.

The charging device 600 for example corresponds to the charging device 400.

Similarly to the charging device 200 shown in FIG. 2, the charging device 600 includes an adaptor element 601, for example an adaptor circuit 601 for AC/DC conversion. The adaptor element 601 supplies electric power to a charging device base 602 of the charging device 600, which, in this example, includes a first power output port 603, which for example supplies power to a USB interface, a second power output port 604, a third power output port 605 and a fourth power output port 606. For example, the first power output port 603 supplies a fixed connection element attached to the charging device base 602 with power and the second power output port 604, the third power output port 605, and the fourth power output port 606 may supply power via (base side) connection interfaces for connecting removable connection elements to the charging device base 602.

In this example, a connection element 607 including a speaker 608 is connected to the charging device base 602 via the second power output port 604 and, for example, via a connection element side connection interface similar to the second connection interfaces 109 described with reference to FIG. 1. The connection element 607 further includes an audio input interface 610 via which it may receive an audio signal and an amplifier 611 coupled to the audio input interface 611 which may be configured to amplify an input audio signal and supply it to the speaker 608 such that the speaker outputs sounds corresponding to the audio signal.

The charging device base 602 may supply power for operating the speaker 608 and the amplifier 611 to the connecting element 607 via the second power output port 604.

Similarly to the charging device 200, the charging device 600 may further include a regulating circuit 609 controlling the power output via the power output ports 603, 604, 605, 606.

For example, the regulating circuit 609 may control the voltage or the current supplied to the connection element 607 according to the requirements of the connection element 607 with regard to the power supply of the speaker or the amplifier. For example, the second power output port 604 outputs 5 V DC power to the connecting element 607.

An audio signal may for example be provided to the connecting element 607 via the audio input interface 610 by a cable and/or a plug connection or, in an embodiment in which the audio input interface 610 supports wireless reception, wirelessly, for example by Bluetooth in an embodiment where a Bluetooth transceiver is integrated in the connection element 607. The audio signal may be provided by an electronic device 612 such as a mobile communication device, a portable MP3 player, or a PDA. The electronic device 612 may be connected itself, directly or via another connection element, to the charging device base 602, for example to the fourth power output port 606 and may be supplied with power (and possibly be charged) by the charging device base 602, while outputting an audio signal, e.g. music data, to the connection element 607, e.g. by cable, via the charging device base 602 or via a wireless connection to the connection element 607 (or also to the charging device base 602), e.g. using Bluetooth.

The charging device 600 may include a volume control allowing a user to control the volume of the audio signals output by the speaker 608. The volume control may include a volume control switch, button, or slider and may be arranged at the connection element 607, i.e. may be part of the connection element 607. Alternatively, the volume control may be arranged as a part of the charging device base 602 in one embodiment.

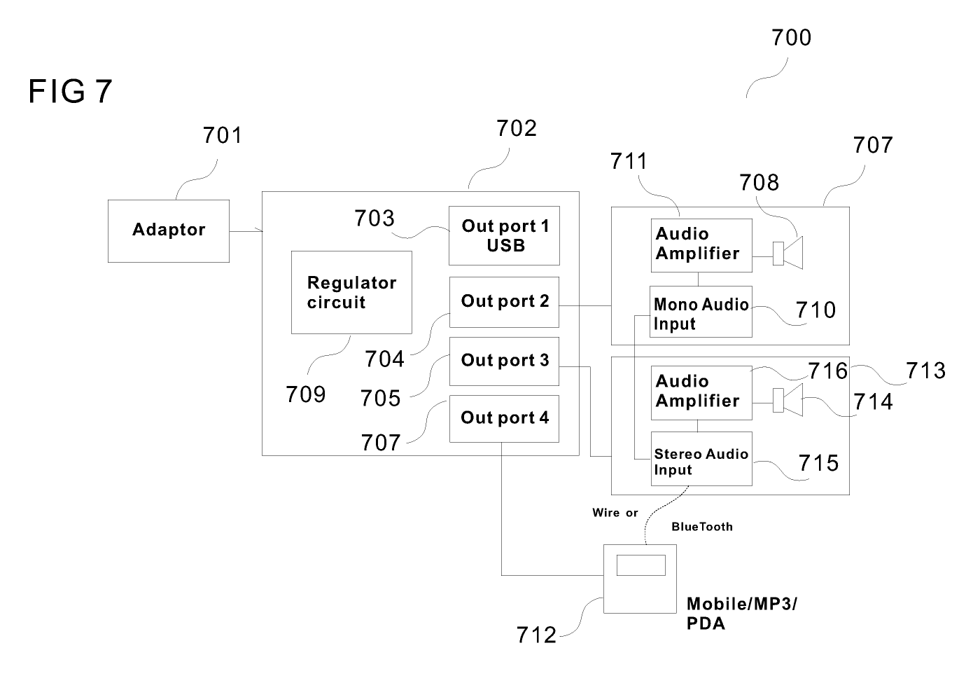

In one embodiment, the connection element 607 alone only may provide mono output of audio signals. However, in one embodiment, two connection elements including speakers may be connected to the charging device base 602 for outputting an audio signal in stereo. This is illustrated in FIG. 7.

FIG. 7 shows a functional view of a charging device 700 according to an embodiment.

Similarly to the charging device 600 described above with reference to FIG. 6, the charging device 700 includes an adaptor element 701, a charging device base 702, a first power output port 703, a second power output port 704, a third power output port 705, a fourth power output port 706, a regulator circuit 709, and a connection element 707 connected to the second power output port 704 including a speaker 708, an amplifier 711, and an audio input interface 710.

In this example, a further connection element 713 including a further speaker 714, a further amplifier 716 and a further audio input interface 715 is connected to the third power output port 705.

The further connection element 713 is configured similarly to the connection element 707 but in this example receives a stereo audio signal from an electronic device 712 (similarly to the scenario described with reference to FIG. 6 for example via cable or wirelessly) and the further audio input interface 715 is a stereo audio input interface forwarding the audio data for one of the two stereo channels to the audio interface 710 and forwarding the audio data for the other of the two stereo channels to the further audio amplifier 716. Thus, the speaker 708 outputs sounds corresponding to one of the two channels of the stereo signal and the further speaker 715 outputs sounds corresponding to the other of the two channels of the stereo signal.

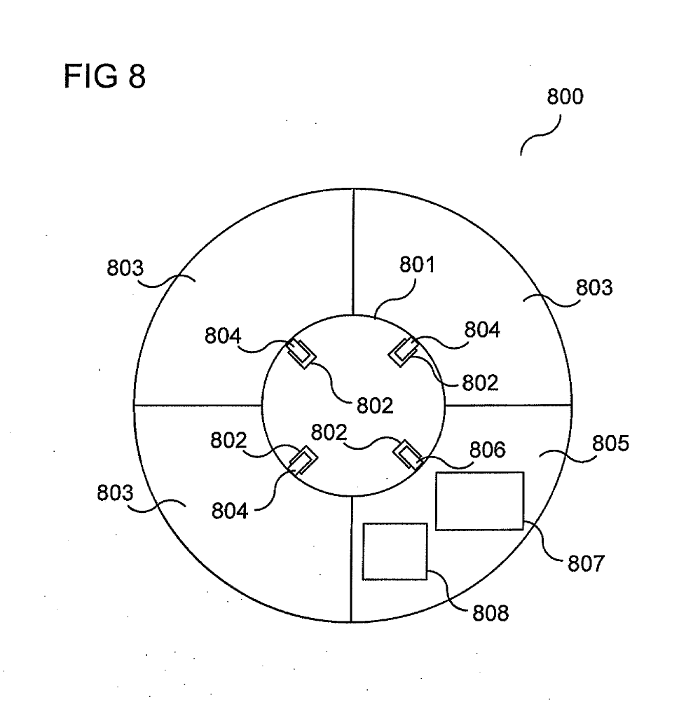

In one embodiment, a connection element may provide a battery compartment for direct charging of batteries (i.e. for charging of batteries not inserted in an electronic device). This is explained in the following with reference to FIG. 8.

FIG. 8 shows a charging device 800 according to an embodiment.

The charging device 800 includes a charging device base 801 including a plurality of first connection element interfaces 802. Further, the charging device 800 includes a plurality of connection elements 803, 805, each connection element 803, 805 including a second connection element interface 804, 806 and being removably coupled with the charging device base 801 by a coupling of its second connection element interface 804, 806 with a first connection element interface 802.

At least one connection element 805 of the plurality of connection elements 803, 805 includes a battery compartment 807 and a battery charging circuit 808 configured to, if a battery is inserted into the battery compartment, receive power and generate, depending on a charging characteristic of the battery, charging power for charging the battery from the received power. The second connection element interface 806 of the at least one connection element 805 is configured such that the battery charging circuit 808, if the second connection element interface 806 is coupled with a first connection element interface 802, receives the power from the charging device base 801 via the second connection element interface 806.

In other words, a portion (e.g. a slot) of the charging device for connecting a connection element is used for connecting a connection element including battery compartment that may be used, instead of charging an electronic device by connecting (e.g. plugging in) the electronic device, for charging of batteries. Thus, the functionality of the charging device may be seen to be extendable (by connecting a corresponding connection element) by a battery charging capability.

In one embodiment, at least one other connection element of the plurality of connection elements includes a charging interface for connecting an electronic device to the connection element such that the electronic device may be charged by the charging device via the charging connection element.

The first connection interfaces may be sockets and the second connection interface may be a corresponding plug. Alternatively, the first connection interface may be plugs and the second connection interface may be a corresponding socket.

In one embodiment, the charging device base includes a center portion and the plurality of first connection element interfaces are arranged such that the plurality of connection elements are arranged around the center portion.

In one embodiment, the at least one connection element further includes a detection circuit configured to detect whether a battery is inserted into the battery compartment, and, if a battery is inserted into the battery compartment, to detect the charging characteristic of the battery.

For example, the charging characteristic specifies a charging voltage of the battery and the battery charging circuit is configured to convert a voltage of the received power to the charging voltage of the charging power for charging the battery.

The charging characteristic may also specify a charging current of the battery and the battery charging circuit may be configured to convert a current of the received power to the charging current of the charging power for charging the battery.

In one embodiment, the charging characteristic specifies a charging level of the battery and the battery charging circuit is configured to supply the charging power to the battery depending on the charging level.

For example, the charging characteristic specifies a charging level of the battery and the battery charging circuit is configured to switch off the supply of the charging power to the battery if the charging level is above a pre-defined threshold.

In one embodiment, the charging characteristic specifies a type of the battery and the battery charging circuit is configured to generate the charging power in accordance with the type of the battery.

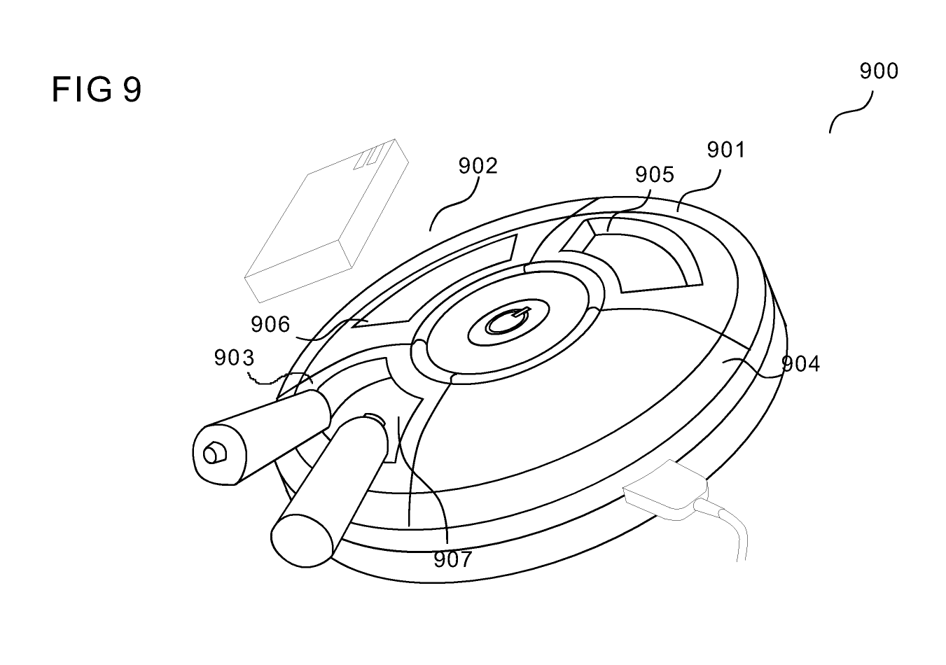

An example for a charging device including connection elements with battery compartments is shown in FIG. 9.

FIG. 9 shows a charging device 900 according to an embodiment.

The charging device 900 includes a plurality of connection elements 901, 902, 903, 904 some of which or all may be removable. In this example a first connection element 901, a second connection element 902, and a third connection element 903 each include a battery compartment 905, 906, 907.

In this example, a fourth connection element 904 is a connection element including a charging interface as explained above with reference to FIG. 1.

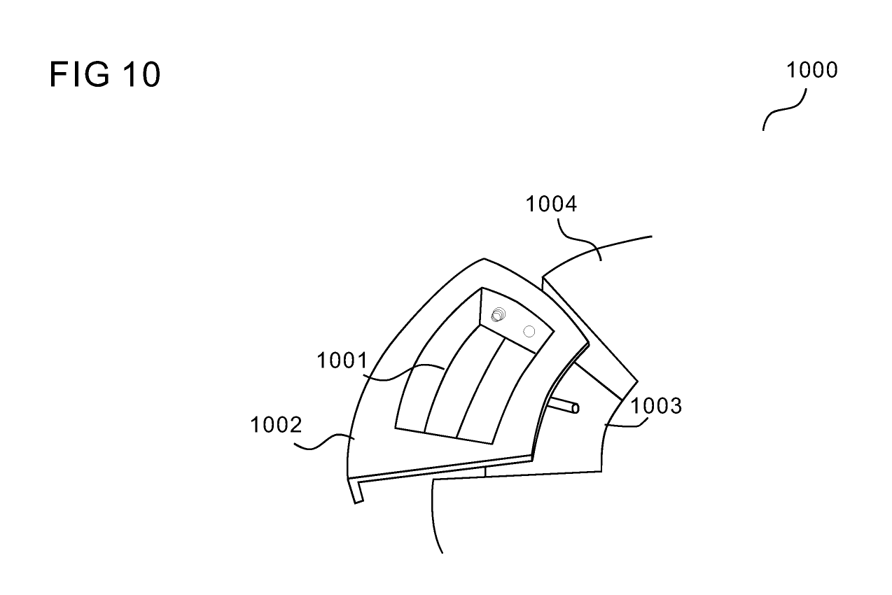

At least one of the first connection element 901, the second connection element 902, and the third connection element 903 may, in one embodiment, be removable from the base of the charging device 900. This is illustrated in FIG. 10.

FIG. 10 shows a connection element 1000 according to an embodiment.

The connection element 1000 for example corresponds to the first connection element 901, the second connection element 902, or the third connection element 903 shown in FIG. 9.

The connection element 900 includes a battery compartment 1001, e.g. formed by a recess in a top 1002 of the connection element 1000.

Power for charging one or more batteries inserted into the battery compartment 1001 may be supplied to the connection element 1000 via a (connection element side) second connection element interface (not shown) which may be coupled to a (base side) first connection element interface 1003 of the charging device base 1004.

The connection element 1000 may be removably attached to the charging device base 1004 similarly to the connection elements 104 of the charging device 100 shown in FIG. 1, for example by a sliding movement in the direction of the center of the charging device base 1004.

The battery compartments 905, 906, 907 may be suitable (e.g. with regard to their shape and size) for different types and different numbers of batteries.

For example, a first battery compartment 905 of the first connection element 901 is a battery compartment for charging one or more rechargeable AA battery cells. A second battery compartment 906 of the second connection element 902 is for example a battery compartment for charging a rechargeable battery pack (e.g. a Li-on battery pack). A third battery compartment 907 of the third connection element 903 is for example a battery compartment for charging one or more AAA battery cells.

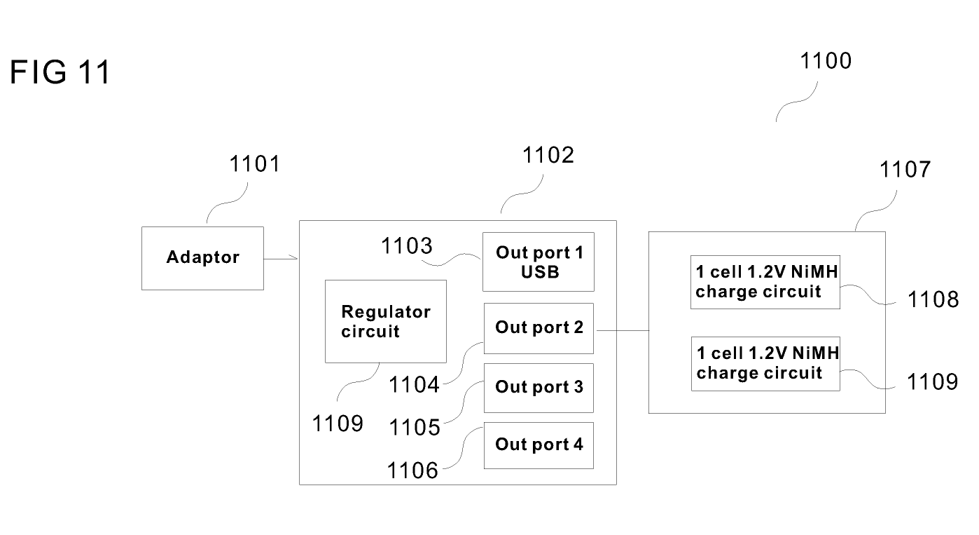

According to the battery compartment 905, 906, 907 of a connection element 901, 902, 903, the connection element 901, 902, 903 may include a battery charging circuit configured to provide power in accordance with the battery or batteries that fit into the battery compartment 905, 906, 907 of the connection element 901, 902, 903. This is illustrated in FIG. 11.

FIG. 11 shows a functional view of a charging device 1100 according to an embodiment.

The charging device 1100 for example corresponds to the charging device 900.

Similarly to the charging device 200 shown in FIG. 2, the charging device 1100 includes an adaptor element 1101, for example an adaptor circuit 1101 for AC/DC conversion. The adaptor element 1101 supplies electric power to a charging device base 1102 of the charging device 1100, which, in this example, includes a first power output port 1103, which is, in this example, a USB power output port, a second power output port 1104, a third power output port 1105 and a fourth power output port 1106. For example, the second power output port 1104 supplies power to a fixed connection element attached to the charging device base 1102 and the second power output port 1104, the third power output port 1105, and the fourth power output port 1106 are (base side) connection interfaces for connecting removable connection elements to the charging device base 1102.

In this example, a connection element 1107 including a battery compartment (not shown) is connected to the charging device base 1102 via the second power output port 1104 and, for example, a connection element side connection interface similar to the second connection interfaces 109 described with reference to FIG. 1.

In this example, it is assumed that the battery compartment of the connection element 1107 is suitable for charging two NiMH (Nickel-metal hydride) batteries in the form of AA battery cells or two NiMH batteries in the form of AAA battery cells. Accordingly, the connection element 1107 includes two battery charging circuits 1108, 1109 wherein each battery charging circuit 1108, 1109 is configured to receive power and generate a charging power for a NiMH battery in accordance with a charging characteristic of the NiMH battery, e.g. in accordance with a required charging voltage (or charging voltage range) or a required charging current (or charging current range).

The power from which the battery charging circuits 1108, 1109 generate the charging power may be supplied by the charging device base 1102, in this case via the second power output port 1104.

The charging device 1100 may further include a regulating circuit 1110 controlling the power output via the power output ports 203, 204, 205, 206. For example, the power supply by the output ports 203, 204, 205, 206 may be turned on or off by the regulating circuit 1110.

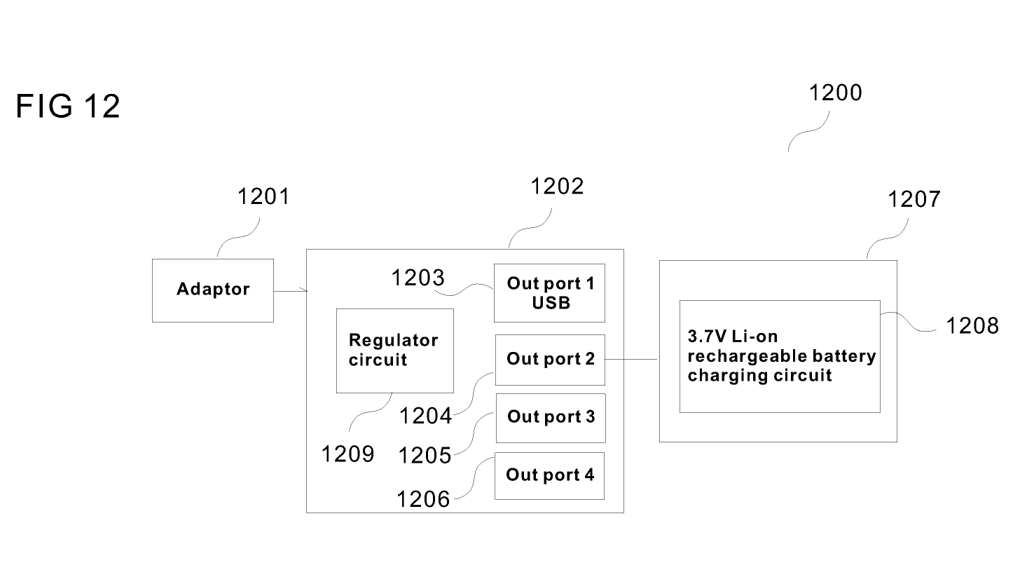

Another example for a charging device including a connection element with a battery compartment is shown in FIG. 12.

FIG. 12 shows a functional view of a charging device 1200 according to an embodiment.

Similarly to the charging device 1100 described above with reference to FIG. 11, the charging device 1200 includes an adaptor element 1201, a charging device base 1202, a first power output port 1203, a second power output port 1204, a third power output port 1205, a fourth power output port 1206, a regulator circuit 1210, and a connection element 1207 connected to the second power output port 1204 including a battery compartment (not shown).

In this example, it is assumed that the battery compartment of the connection element 1207 is suitable (e.g. regarding its size and shape) for one Li-on (Lithium Ion) battery pack. Accordingly, the connection element 1207 includes a battery charging circuit 1208 configured to receive power and generate a charging power for a Li-on battery pack in accordance with a charging characteristic of the Li-on battery pack, e.g. in accordance with a required charging voltage (or charging voltage range) or a required charging current (or charging current range).

The power from which the battery charging circuit 1208 generates the charging power may be supplied by the charging device base 1202, in this case via the second power output port 1204.

In this example, the second power output port 1204, the third power output port 1205, and the fourth power output port 1206 may each be used to supply a connection element with a battery compartment for charging batteries. In this example, since the first power output port 1203 is a USB port, a connection element with a battery compartment cannot be connected to the first power output port 1203.

In one embodiment, the charging device base 1102, 1202 or the connection element 1107, 1207 includes a detection circuit configured to determine a charging characteristic of a battery inserted in the battery compartment of the connection element 1107, 1207. For example, the detection circuit may determine the type of a battery inserted in the battery compartment. The detection circuit or a corresponding control circuit may then control the charging circuit to charge the battery in accordance with the charging characteristic that has been detected.

The charging device 1100, 1200 may include an indicator configured to indicate whether a battery is currently being charged. Such an indicator may for example be in the form of an LED (Light Emitting Diode) and may be arranged at the connection element 1107, 1207 i.e. may be part of the connection element 1107, 1207. For example, such an indicator may be provided for each battery compartment to indicate whether a battery is currently being charged by means of the respective battery compartment.

In one embodiment, such an indicator may also be arranged as a part of the charging device base 1102, 1202.

In various embodiments, a charging device is provided. The charging device may include a charging device base having a plurality of first connection element interfaces; and a plurality of connection elements, each connection element including a second connection element interface and being removably coupled with the charging device base by a coupling of its second connection element interface with a first connection element interface, wherein at least one connection element of the plurality of connection elements comprises a speaker, wherein the second connection element interface of the at least one connection element is configured such that the connection element, if the second connection element interface is coupled with a first connection element interface, receives power from the charging device base for operating the speaker, and wherein the at least one connection element comprises an audio interface for receiving an audio signal and is configured to output sounds corresponding to the audio signal using the speaker.

In an implementation of these embodiments, at least one other connection element of the plurality of connection elements may include a charging interface for connecting an electronic device to the connection element such that the electronic device may be charged by the charging device via the charging connection element.

In another implementation of these embodiments, the charging device base may include a base output audio interface configured to output the audio signal to the audio interface of the connection element.

In yet another implementation of these embodiments, the first connection interfaces are sockets and the second connection interface is a corresponding plug.

In yet another implementation of these embodiments, the first connection interfaces are plugs and the second connection interface is a corresponding socket.

In yet another implementation of these embodiments, the charging device base may include a center portion and the plurality of first connection element interfaces are arranged such that the plurality of connection elements are arranged around the center portion.

In yet another implementation of these embodiments, the audio interface is a wireless audio interface configured to receive the audio signal wirelessly.

In yet another implementation of these embodiments, the audio interface is a radio interface configured to receive the audio signal via a radio signal.

In yet another implementation of these embodiments, the at least one connection element may include an audio amplifier for amplifying the audio signal.

In yet another implementation of these embodiments, the audio interface is configured to receive a stereo audio signal comprising a first channel audio signal and a second channel audio signal, the connection element comprises an output audio interface and the audio interface of the connection element is configured to output the first channel audio signal to the output audio interface and the connection element is configured to output sounds corresponding to the second channel audio signal using the speaker.

In various embodiments, a connection element for the charging device as described above is provided. The connection element may include a speaker; a second connection element interface configured such that the connection element, if the second connection element interface is coupled with a first connection element interface of the charging device base, receives power from the charging device base for operating the speaker; and an audio interface for receiving an audio signal wherein the connection element is configured to output sounds corresponding to the audio signal using the speaker.

In yet another implementation of these embodiments, the audio interface is a wireless audio interface configured to receive the audio signal wirelessly.

In yet another implementation of these embodiments, the audio interface is a radio interface configured to receive the audio signal via a radio signal.

In yet another implementation of these embodiments, the at least one connection element may include an audio amplifier for amplifying the audio signal.

In yet another implementation of these embodiments, the audio interface is configured to receive a stereo audio signal comprising a first channel audio signal and a second channel audio signal, the connection element comprises an output audio interface and the audio interface of the connection element is configured to output the first channel audio signal to the output audio interface and the connection element is configured to output sounds corresponding to the second channel audio signal using the speaker.

In various embodiments, a charging device is provided. The charging device may include a charging device base including a plurality of first connection element interfaces; and a plurality of connection elements, each connection element including a second connection element interface and being removably coupled with the charging device base by a coupling of its second connection element interface with a first connection element interface; wherein at least one connection element of the plurality of connection elements may include a battery compartment, a battery charging circuit configured to, if a battery is inserted into the battery compartment, receive power and generate, depending on a charging characteristic of the battery, charging power for charging the battery from the received power, wherein the second connection element interface of the at least one connection element is configured such that the battery charging circuit, if the second connection element interface is coupled with a first connection element interface, receives the power from the charging device base via the second connection element interface.

In an implementation of these embodiments, at least one other connection element of the plurality of connection elements may include a charging interface for connecting an electronic device to the connection element such that the electronic device may be charged by the charging device via the charging connection element.

In another implementation of these embodiments, the first connection interfaces are sockets and the second connection interface is a corresponding plug.

In yet another implementation of these embodiments, the first connection interfaces are plugs and the second connection interface is a corresponding socket.

In yet another implementation of these embodiments, the charging device base may include a center portion and the plurality of first connection element interfaces are arranged such that the plurality of connection elements are arranged around the center portion.

In yet another implementation of these embodiments, the at least one connection element may further include a detection circuit configured to detect whether a battery is inserted into the battery compartment, and, if a battery is inserted into the battery compartment, to detect the charging characteristic of the battery.

In yet another implementation of these embodiments, the charging characteristic specifies a charging voltage of the battery and the battery charging circuit is configured to convert a voltage of the received power to the charging voltage of the charging power for charging the battery.

In yet another implementation of these embodiments, the charging characteristic specifies a charging current of the battery and the battery charging circuit is configured to convert a current of the received power to the charging current of the charging power for charging the battery.

In yet another implementation of these embodiments, the charging characteristic specifies a charging level of the battery and the battery charging circuit is configured to supply the charging power to the battery depending on the charging level.

In yet another implementation of these embodiments, the charging characteristic specifies a charging level of the battery and the battery charging circuit is configured to switch off the supply of the charging power to the battery if the charging level is above a pre-defined threshold.

In yet another implementation of these embodiments, the charging characteristic specifies a type of the battery and the battery charging circuit is configured to generate the charging power in accordance with the type of the battery.

In various embodiments, a connection element for the charging device as described above is provided. The connection element may include a battery compartment; a battery charging circuit configured to, if a battery is inserted into the battery compartment, receive power and generate, depending on a charging characteristic of the battery, charging power for charging the battery from the received power; and a second connection element interface configured such that the battery charging circuit, if the second connection element interface is coupled with a first connection element interface of the charging device base, receives the power from the charging device base.

In yet another implementation of these embodiments, the connection element may further include a detection circuit configured to detect whether a battery is inserted into the battery compartment, and, if a battery is inserted into the battery compartment, to detect the charging characteristic of the battery.

In yet another implementation of these embodiments, the charging characteristic specifies a charging voltage of the battery and the battery charging circuit is configured to convert a voltage of the received power to the charging voltage of the charging power for charging the battery.

In yet another implementation of these embodiments, the charging characteristic specifies a charging current of the battery and the battery charging circuit is configured to convert a current of the received power to the charging current of the charging power for charging the battery.

In yet another implementation of these embodiments, the charging characteristic specifies a charging level of the battery and the battery charging circuit is configured to supply the charging power to the battery depending on the charging level.

In yet another implementation of these embodiments, the charging characteristic specifies a charging level of the battery and the battery charging circuit is configured to switch off the supply of the charging power to the battery if the charging level is above a pre-defined threshold.

In yet another implementation of these embodiments, the charging characteristic specifies a type of the battery and the battery charging circuit is configured to generate the charging power in accordance with the type of the battery.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A charging device, comprising:
a charging device base comprising a plurality of first connection element interfaces; and
a plurality of connection elements, each connection element comprising a second connection element interface and being removably coupled with the charging device base by a coupling of its second connection element interface with a first connection element interface;
wherein at least one connection element of the plurality of connection elements comprises a speaker;
wherein the second connection element interface of the at least one connection element is configured such that the connection element, if the second connection element interface is coupled with a first connection element interface, receives power from the charging device base for operating the speaker; and
wherein the at least one connection element comprises an audio interface for receiving an audio signal and is configured to output sounds corresponding to the audio signal using the speaker.

2. The charging device according to claim 1,
wherein at least one other connection element of the plurality of connection elements comprises a charging interface for connecting an electronic device to the connection element such that the electronic device may be charged by the charging device via the charging connection element.

3. The charging device according to claim 1,
wherein the charging device base comprises a base output audio interface configured to output the audio signal to the audio interface of the connection element.

4. The charging device according to claim 1,
wherein the first connection interfaces are sockets and the second connection interface is a corresponding plug.

5. The charging device according to claim 1,
wherein the first connection interfaces are plugs and the second connection interface is a corresponding socket.

6. The charging device according to claim 1,
wherein the charging device base comprises a center portion and the plurality of first connection element interfaces are arranged such that the plurality of connection elements are arranged around the center portion.

7. The charging device according to claim 1,
wherein the audio interface is a wireless audio interface configured to receive the audio signal wirelessly.

8. The charging device according to 7,
wherein the audio interface is a radio interface configured to receive the audio signal via a radio signal.

9. The charging device according to claim 1,
wherein the at least one connection element comprises an audio amplifier for amplifying the audio signal.

10. The charging device according to claim 1,
wherein the audio interface is configured to receive a stereo audio signal comprising a first channel audio signal and a second channel audio signal, the connection element comprises an output audio interface and the audio interface of the connection element is configured to output the first channel audio signal to the output audio interface and the connection element is configured to output sounds corresponding to the second channel audio signal using the speaker.

11. A connection element for the charging device of claim 1, the connection element comprising:
a speaker;
a second connection element interface configured such that the connection element, if the second connection element interface is coupled with a first connection element interface of the charging device base, receives power from the charging device base for operating the speaker; and
an audio interface for receiving an audio signal wherein the connection element is configured to output sounds corresponding to the audio signal using the speaker.

12. The connection element according to claim 11,
wherein the audio interface is a wireless audio interface configured to receive the audio signal wirelessly.

13. The connection element device according to 12,
wherein the audio interface is a radio interface configured to receive the audio signal via a radio signal.

14. The connection element according to claim 1,
wherein the at least one connection element comprises an audio amplifier for amplifying the audio signal.

15. The connection element according to claim 11,
wherein the audio interface is configured to receive a stereo audio signal comprising a first channel audio signal and a second channel audio signal, the connection element comprises an output audio interface and the audio interface of the connection element is configured to output the first channel audio signal to the output audio interface and the connection element is configured to output sounds corresponding to the second channel audio signal using the speaker.

16. A charging device, comprising:
a charging device base comprising a plurality of first connection element interfaces; and
a plurality of connection elements, each connection element comprising a second connection element interface and being removably coupled with the charging device base by a coupling of its second connection element interface with a first connection element interface;
wherein at least one connection element of the plurality of connection elements comprises
a battery compartment;
a battery charging circuit configured to, if a battery is inserted into the battery compartment, receive power and generate, depending on a charging characteristic of the battery, charging power for charging the battery from the received power, wherein the second connection element interface of the at least one connection element is configured such that the battery charging circuit, if the second connection element interface is coupled with a first connection element interface, receives the power from the charging device base via the second connection element interface.

17. The charging device according to claim 16,
wherein at least one other connection element of the plurality of connection elements comprises a charging interface for connecting an electronic device to the connection element such that the electronic device may be charged by the charging device via the charging connection element.

18. The charging device according to claim 16,
wherein the first connection interfaces are sockets and the second connection interface is a corresponding plug.

19. The charging device according to claim 16,
wherein the first connection interfaces are plugs and the second connection interface is a corresponding socket.

20. The charging device according to claim 16,
wherein the charging device base comprises a center portion and the plurality of first connection element interfaces are arranged such that the plurality of connection elements are arranged around the center portion.
